(19) United States
(12) Patent Application Publication
(10) Pub. No.: US 2021/0253781 A1
(43) Pub. Date: Aug. 19, 2021

(54) REACTION SYSTEM FOR A ONE COMPONENT RIGID POLYURETHANE FOAM

(71) Applicant: Covestro Intellectual Property GmbH & Co. KG, Leverkusen (DE)

(72) Inventors: Reinhard Albers, Leverkusen (DE); Marion Frommont, Leverkusen (DE); Patrick Klasen, Vettweiß (DE); Erhard Michels, Köln (DE)

(21) Appl. No.: 17/253,172

(22) PCT Filed: Jul. 8, 2019
(86) PCT No.: PCT/EP2019/068192

§ 371 Date: Dec. 17, 2020

(30) Foreign Application Priority Data
Jul. 10, 2018 (EP) 18182568.8

(51) Int. Cl. C08G 18/76; C08G 18/48; C08J 9/14; C08K 5/5419; C08G 18/16

(52) U.S. Cl. CPC C08G 18/7621; C08G 18/4829; C08J 9/141; C08K 5/5419; C08J 2375/08; C08J 9/149; C08G 18/166; C08J 2205/10; C08J 9/142

(57) ABSTRACT

The invention relates to a one-component reaction system for producing rigid polyurethane foams (also called rigid PUR foams) having improved dimensional stability, to methods for producing same and the use thereof. The invention also relates to the rigid polyurethane foams produced using the one-component reaction system according to the invention.

The present invention relates to a one-component reaction system (also known as a 1K-reaction system) containing polyether carbonate polyol for producing rigid polyurethane foams (also known as rigid PUR foams), to processes for the production thereof and to the use thereof. The invention further relates to the rigid polyurethane foams produced from the one-component reaction system according to the invention.

In the context of an environmentally friendly configuration of production processes, it is generally desirable to use CO₂-based starting materials, for example in the form of polyether carbonate polyols, in relatively large amounts. The production of polyether carbonate polyols by catalytic reaction of alkylene oxides (epoxides) and carbon dioxide in the presence of H-functional starter compounds (“starters”) has been the subject of intensive study for more than 40 years (e.g. Inoue et al., Copolymerization of Carbon Dioxide and Epoxide with Organometallic Compounds; Die Makromolekulare Chemie 130, 210-220, 1969). This reaction is shown in schematic form in scheme (I), where R is an organic radical such as alkyl, alkylaryl or aryl, each of which may also contain heteroatoms, for example O, S, Si, etc., and where e, f and g are each integers, and where the product shown here in scheme (I) for the polyether carbonate polyol should merely be understood in such a way that blocks having the structure shown may in principle be present in the polyether carbonate polyol obtained, but the sequence, number and length of the blocks and the OH functionality of the starter may vary and is not restricted to the polyether carbonate polyol shown in scheme (I). This reaction (see scheme (I)) is highly advantageous from an environmental standpoint since this reaction is the conversion of a greenhouse gas such as CO₂ to a polymer. A further product formed, actually a by-product, is the cyclic carbonate shown in scheme (I) (for example propylene carbonate when R═CH₃, also referred to hereinafter as cPC, or ethylene carbonate when R═H, also referred to hereinafter as cEC).

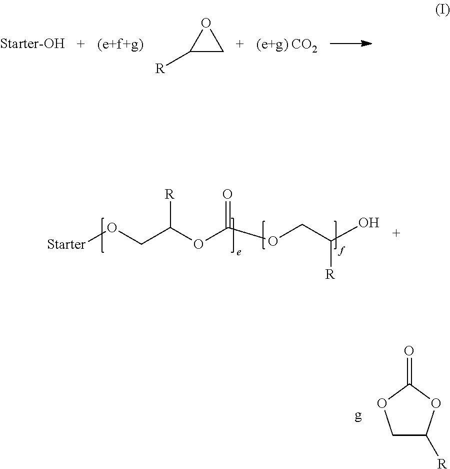

Processes for producing polyurethane foams based on polyether carbonate polyols and isocyanates are known (for example WO 2012/130760 A1, EP-A 0 222 453).

Production of polyurethane foams from single-use containers is likewise known from the prior art. This comprises producing an isocyanate-containing prepolymer by reaction of a polyol component with organic di- and/or polyisocyanates with addition of foam stabilizers and catalysts and optionally of plasticizers, flame retardants, crosslinkers and further additives. This reaction is normally carried out in the presence of blowing agents in a pressurized container. After completion of the prepolymer formation the polyurethane foam may then be dispensed in a controlled manner via a valve. The polyurethane foam initially has a creamy consistency and then subsequently cures through exposure to ambient humidity, for example from the air, to undergo volume expansion. Such foams are therefore referred to as one-component foams (1K foams).

In order to obtain the desired end properties of the foam such as for example hardness or cellularity a marked excess of the isocyanate over the polyol component is employed. This serves to control the so-called advancement and hence the molecular weight distribution of the prepolymer. The lower the advancement of the prepolymer, the narrower the molecular weight distribution, and the more precisely adjustable are the final properties of the cured PUR foam.

A large field of application for 1K foams is the construction industry where rigid PUR foams having good dimensional stability (low swellage/shrinkage) are desired. Rigid PUR foams having low swellage/shrinkage have the feature that foam-comprising components require less in the way of further processing in a further operating step (for example by cutting to size). There is also a danger that the geometry of the foam-comprising components changes as a result of excessive swellage/shrinkage of the foam. Foams having low swellage/shrinkage are also easier to meter.

WO 2011/138274 A1 discloses prepolymers obtained by reaction of polyisocyanates and polyether carbonate diols. These prepolymers may be used for example to produce one-component coatings having improved hardness. However, WO 2011/138274 A1 does not disclose a one-component reaction system affording rigid polyurethane foams and thus also does not demonstrate any effect on the dimensional stability of rigid polyurethane foams made of one-component reaction systems.

Starting from the prior art the present invention had for its object to provide a 1K polyurethane formulation that affords rigid polyurethane foams which are readily dispensable but also strong after curing and which exhibit good dimensional stability.

This object was surprisingly achieved by the inventive one-component reaction system for producing rigid polyurethane foams comprising the constituents:
A) at least one organic polyisocyanate component,
B) at least one isocyanate-reactive component whose isocyanate-reactive functional groups are exclusively those having at least one Zerewitinoff-reactive hydrogen atom,
C) at least one foam stabilizer,
D) at least one catalyst suitable for catalyzing the reaction of the polyisocyanate component A) with the isocyanate-reactive component B),
E) at least one physical blowing agent having a boiling point of less than 0° C. and optionally co-blowing agents and
F) optionally assistant and additive substances,
characterized in that
the one-component reaction system contains at least 10% by weight, based on the sum of the weight fractions of A) to F)=100% by weight, of a polyether carbonate polyol.

The invention further relates to a process for producing a one-component reaction system, to a process for producing rigid polyurethane foams from a one-component reaction system, to a rigid polyurethane foam obtainable from a one-component reaction system, to the use of a one-component reaction system as a one-component expanding foam (also known as 1K expanding foam) and to a pressurized container containing a one-component reaction system and a blowing agent.

In the context of the present application the “functionality Fₙ” of a polyol/a polyol mixture is the number-averaged functionality of the polyol mixture of polyol 1 . . . polyol i calculated by way of Fₙ =ΣxᵢFᵢ where xᵢ=mole fraction and Fᵢ=starter functionality of the polyol i.

The equivalent weight specifies the ratio of the number-average molecular weight to the functionality of the isocyanate-reactive component. The reported equivalent weights for mixtures are calculated from equivalent weights of the individual components in their respective molar proportions and relate to the number-average equivalent weight of the mixture.

In the context of the present application “molecular weight” or “molar mass” is understood as meaning the number-weighted average molecular weight.

The index specifies the percentage ratio of the actually employed isocyanate amount to the stoichiometric amount of isocyanate groups (NCO), i.e. the amount calculated for conversion of the OH equivalents.

Employed as organic polyisocyanate component A) in a proportion of 90% to 100% by weight, preferably of 95% to 100% by weight, particularly preferably of 98% to 100% by weight, based on the total weight of A), are aromatic polyisocyanates, for example 2,4- or 2,6-tolylene diisocyanate (TDI), 1,5-naphthylene diisocyanate, 2,2′- or 2,4′- or 4,4′-diphenylmethane diisocyanate (monomeric MDI) or higher homologues (polymeric MDI), 1,3- or 4-bis(2-isocyanato-prop-2-yl)benzene (TMXDI), 1,3-bis(isocyanatomethyl)benzene (XDI) or further aromatic organic polyisocyanates of the type known per se from polyurethane chemistry individually or as mixtures. The organic polyisocyanate component A) preferably contains at least 80% by weight, particularly preferably at least 85% by weight and especially preferably at least 95% by weight, based on the total weight of A), of monomeric and/or polymeric MDI. The organic polyisocyanate component A) may additionally comprise small proportions of 0% to 10% by weight, preferably 0% to 5% by weight, particularly preferably 0% to 2% by weight, based on the total weight of A), of nonaromatic organic isocyanates. In a particularly preferred embodiment the organic polyisocyanate component A) contains only monomeric and/or polymeric MDI or contains at most technically unavoidable traces of further isocyanates as a consequence of production. The proportion of organic polyisocyanate component A) in the one-component reaction system is preferably 30% to 80% by weight, particularly preferably 35% to 75% by weight, especially preferably 40% to 70% by weight, in each case based on A)+B)+C)+D)+E)+F)=100% by weight.

The isocyanate-reactive component B) is a component whose isocyanate-reactive functional groups are exclusively those having at least one Zerewitinoff-reactive hydrogen atom. The isocyanatereactive component B) contains at least one polyether carbonate polyol having a proportion of at least 15% by weight, preferably at least 18% by weight, particularly preferably at least 20% by weight, especially preferably at least 22% by weight, based on the sum of the weight fractions of A) to F), in the one-component reaction system. Further polyols such as for example polyether polyols, polyester polyols and/or polyether ester polyols may be present in the isocyanate-reactive component B) in addition to the polyether carbonate polyol.

Polyether carbonate polyols are produced by addition of alkylene oxide and carbon dioxide onto one or more H-functional starter substances in the presence of a double metal cyanide catalyst (DMC catalyst) or of a metal complex catalyst based on the metals zinc and/or cobalt, preferably by means of the steps:
(α) initially charging a portion of the H-functional starter compound and/or suspension medium having no H-functional groups in a reactor optionally together with DMC catalyst or a metal complex catalyst based on the metals zinc and/or cobalt,
(β) optionally adding a portion (based on the total amount of alkylene oxide used in the activation and copolymerization) of alkylene oxide to the mixture resulting from step (α) to activate a DMC catalyst, wherein this addition of a portion of alkylene oxide can optionally be carried out in the presence of CO₂ and wherein the temperature spike (“hotspot”) occurring on account of the subsequent exothermic chemical reaction and/or a pressure drop in the reactor is awaited in each case and wherein step (β) for activation may also be carried out two or more times.
(γ) adding H-functional starter substance, alkylene oxide and optionally DMC catalyst and/or carbon dioxide into the reactor.

Production of a polyether carbonate polyol may generally be carried out using alkylene oxides (epoxides) having 2 to 24 carbon atoms. The alkylene oxides having 2 to 24 carbon atoms are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1 ,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, mono- or polyepoxidized fats as mono-, di- and triglycerides, epoxidized fatty acids, C1-C24 esters of epoxidized fatty acids, epichlorohydrin, glycidol, and derivatives of glycidol, for example methyl glycidyl ether, ethyl glycidyl ether, 2-ethylhexyl glycidyl ether, allyl glycidyl ether, glycidyl methacrylate and epoxy-functional alkoxysilanes, for example 3 -glycidyloxypropyltrimethoxysilane, 3-glycidyloxypropyltriethoxysilane, 3-glycidyloxypropyltripropoxysilane, 3 -glycidyloxypropylmethyldimethoxysilane, 3-glycidyloxypropylethyldiethoxysilane, 3 -glycidyloxypropyltriisopropoxysilane. The alkylene oxides used are preferably ethylene oxide and/or propylene oxide and/or 1,2-butylene oxide, particularly preferably propylene oxide.

Suitable H-functional starter compounds that may be used include compounds having alkoxylation-active H atoms. Alkoxylation-active groups having active H atoms are, for example, —OH, —NH₂ (primary amines), —NH— (secondary amines), —SH and —CO₂H, preferably —OH and —NH₂, particularly preferably —OH.

Employable monofunctional starter compounds are alcohols, amines, thiols, and carboxylic acids. Monofunctional alcohols that may be used include: methanol, ethanol, 1-propanol, 2-propanol, 1-butanol, 2-butanol, t-butanol, 3-buten-1-ol, 3-butyn-1-ol, 2-methyl-3-buten-2-ol, 2-methyl-3-butyn-2-ol, propargyl alcohol, 2-methyl-2-propanol, 1-t-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Suitable monofunctional amines include: butylamine, t-butylamine, pentylamine, hexylamine, aniline, aziridine, pyrrolidine, piperidine, morpholine. Employable monofunctional thiols include: ethanethiol, 1-propanethiol, 2-propanethiol, 1-butanethiol, 3-methyl-l-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Examples of polyhydric alcohols suitable as H-functional starter compounds include dihydric alcohols (for example ethylene glycol, diethylene glycol, propylene glycol, dipropylene glycol, propane-1,3-diol, butane-1,4-diol, butene-1,4-diol, butyne-1,4-diol, neopentyl glycol, pentantane-1,5-diol, methylpentanediols (for example 3-methylpentane-1,5-diol), hexane-1,6-diol, octane-1,8-diol, decane-1,10-diol, dodecane-1,12-diol, bis(hydroxymethyl)cyclohexanes (for example 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (for example trimethylolpropane, glycerol, trishydroxyethyl isocyanurate, castor oil); tetrahydric alcohols (for example pentaerythritol); polyalcohols (for example sorbitol, hexitol, sucrose, starch, starch hydrolyzates, cellulose, cellulose hydrolyzates, hydroxyfunctionalized fats and oils, especially castor oil), and also all products of modification of these aforementioned alcohols having different amounts of E-caprolactone. Also employable in mixtures of H-functional starter compounds are trihydric alcohols, for example trimethylolpropane, glycerol, trishydroxyethyl isocyanurate, and castor oil.

The H-functional starter compounds may also be selected from the substance class of the polyether polyols, in particular those having a molecular weight Mₙ in the range from 100 to 4000 g/mol, preferably 250 to 2000 g/mol. Preference is given to polyether polyols constructed from repeating ethylene oxide and propylene oxide units, preferably having a proportion of propylene oxide units of from 35% to 100%, particularly preferably having a proportion of propylene oxide units of from 50% to 100%. These may be random copolymers, gradient copolymers, alternating copolymers or block copolymers of ethylene oxide and propylene oxide. Suitable polyether polyols constructed from repeating propylene oxide and/or ethylene oxide units are for example the Desmophen®, Acclaim®, Arcol®, Baycoll®, Bayfill®, Bayflex®, Baygal®, PET® and Polyether polyols from Covestro Deutschland AG (e.g. Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are for example the Pluriol® E products from BASF SE, suitable homopolypropylene oxides are for example the Pluriol® P products from BASF SE, suitable mixed copolymers of ethylene oxide and propylene oxide are for example the Pluronic® PE or Pluriol® RPE products from BASF SE.

The H-functional starter compounds can also be selected from the substance class of the polyester polyols, in particular those having a molecular weight Mₙ in the range from 200 to 4500 g/mol, preferably from 400 to 2500 g/mol. At least bifunctional polyesters are used as the polyester polyols. Polyester polyols preferably consist of alternating acid and alcohol units. Acid components employed include, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Alcohol components used are, for example, ethanediol, propane-1,2-diol, propane-1,3-diol, butane-1,4-diol, pentane-1,5-diol, neopentyl glycol, hexane-1,6-diol, 1,4-bis(hydroxymethyl)cyclohexane, diethylene glycol, dipropylene glycol, trimethylolpropane, glycerol, pentaerythritol or mixtures of the alcohols mentioned. Employing dihydric or polyhydric polyether polyols as the alcohol component affords polyester ether polyols which can likewise serve as starter compounds for producing the polyether carbonate polyols. If polyether polyols are used for producing the polyester ether polyols, preference is given to polyether polyols having a number-average molecular weight Mₙ of 150 to 2000 g/mol.

Also employable as H-functional starter compounds are polycarbonate polyols (for example polycarbonate diols), especially those having a molecular weight Mₙ in the range from 150 to 4500 g/mol, preferably 500 to 2500, which are produced for example by reaction of phosgene, dimethyl carbonate, diethyl carbonate or diphenyl carbonate and di- and/or polyfunctional alcohols or polyester polyols or polyether polyols. Examples of polycarbonate polyols can be found, for example, in EP-A 1359177. For example, the polycarbonate diols used may be the Desmophen® C products from Covestro Deutschland AG, for example Desmophen® C 1100 or Desmophen® C 2200.

In addition, the component B) may contain proportions of further polyols, for example polyether polyols, polyester polyols and/or polyether ester polyols.

The polyether polyols are preferably polyhydroxy polyethers, which can be produced in a manner known per se by polyaddition of the alkylene oxides already described above onto polyfunctional starter compounds in the presence of catalysts. It is preferable when the polyhydroxy polyethers are produced from a starter compound having on average 2 to 8 active hydrogen atoms and one or more alkylene oxides. Preferred starter compounds are molecules having two to eight hydroxyl groups per molecule such as water, ethylene glycol, propylene glycol, diethylene glycol, dipropylene glycol, triethylene glycol, tripropylene glycol, 1,4-butanediol, 1,6-hexanediol, triethanolamine, glycerol, trimethylolpropane, pentaerythritol, sorbitol and sucrose. The starter compounds may be used alone or in admixture. The starter compounds are produced with an alkylene oxide, preferably with ethylene oxide and/or propylene oxide. When using them in admixture the alkylene oxides may be reacted in random and/or blockwise fashion. Also suitable are relatively high molecular weight polyhydroxy polyethers in which high molecular weight polyadducts or polycondensates or polymers are present in finely dispersed, dissolved or grafted form. Such modified polyhydroxy compounds are obtained for example when polyaddition reactions (for example reactions between polyisocyanates and amino-functional compounds) or polycondensation reactions (for example between formaldehyde and phenols and/or amines) are allowed to take place in situ in the hydroxyl-containing compounds (as described for example in DE-AS 1 168 075). Polyhydroxyl compounds modified by vinyl polymers such as are obtained for example by polymerization of styrene and acrylonitrile in the presence of polyethers (for example according to US-PS 3 383 351) are also suitable as isocyanate-reactive component B) for the process according to the invention. Representatives of the recited component B) are described for example in Kunststoff-Handbuch, Volume VII “Polyurethanes”, 3rd edition, Carl Hanser Verlag, Munich/Vienna, 1993, pages 57-67 and pages 88-90.

It is preferable to employ a polyether carbonate polyol having a functionality of 1.0 to 4.0, particularly preferably 1.5 to 3.5, especially preferably 1.9 to 3.0. The hydroxyl number of the polyether carbonate polyol may be for example 10 to 800 mg KOH/g, preferably 25 to 500 mg KOH/g, particularly preferably 50 to 300 mg KOH/g, especially preferably 100 to 250 mg KOH/g.

The compounds employed as isocyanate-reactive component B) may likewise be in the form of prepolymers. Production of a prepolymer may in principle be carried out in any manner known to those skilled in the art. In an advantageous embodiment said prepolymer is produced by reaction of at least one isocyanate-reactive component B) with an excess of the organic polyisocyanate compound A) optionally followed by partial distillative removal of the unreacted polyisocyanate component A) down to the desired content of free isocyanate. Reaction of the components A) and B) may be carried out in the presence of a catalyst component catalytically active for the pre-polymerization (“pre-polymerization catalyst”) but it is preferable when the reaction is not carried out in the presence of a pre-polymerization catalyst, i.e. at most technically unavoidable traces of a pre-polymerization catalyst are present.

The compounds described for use as isocyanate-reactive component B) may be employed individually or as mixtures, wherein the isocyanate-reactive compound preferably comprises
an (average) OH number of 100 to 400 mg KOH/g, particularly preferably 150 to 300 mg KOH/g, and/or
a functionality Fₙ of 1.0 to 4.0, particularly preferably 1.5 to 3.5, especially preferably 1.8 to 3.0.

The proportion of the isocyanate-reactive component B) in the one-component reaction system is preferably 15% to 50% by weight, particularly preferably 25% to 45% by weight, especially preferably 28% to 40% by weight, in each case based on A)+B)+C)+D)+E)+F)=100% by weight.

In a preferred embodiment the isocyanate-reactive component B) contains at least one polyether carbonate polyol in a proportion of 10% to 50% by weight, preferably 18% to 50% by weight, particularly preferably 20% to 45% by weight, especially preferably 22% to 40% by weight, in each case based on A)+B)+C)+D)+E)+F)=100% by weight.

In a further preferred embodiment the isocyanate-reactive component B) contains at least one polyether carbonate polyol in a proportion of 30% to 100% by weight, preferably 50% to 100% by weight, particularly preferably 80% to 100% by weight, in each case based on B)=100% by weight.

The one-component reaction system further contains at least one foam stabilizer C). These may be selected from silicone-containing foam stabilizers, such as siloxane-oxyalkylene copolymers and other organopolysiloxanes, and also alkoxylation products of fatty alcohols, oxo alcohols, fatty amines, alkyphenols, dialkylphenols, alkylcresols, alkylresorcinol, naphthol, alkylnaphthol, naphthylamine, aniline, alkylaniline, toluidine, bisphenol A, alkylated bisphenol A or polyvinyl alcohol, and also alkoxylation products of condensates of formaldehyde and alkylphenols, formaldehyde and dialkylphenols, formaldehyde and alkylcresols, formaldehyde and alkylresorcinol, formaldehyde and aniline, formaldehyde and toluidine, formaldehyde and naphthol, formaldehyde and alkylnaphthol and also formaldehyde and bisphenol A. Employable alkoxylation reagents include for example ethylene oxide and/or propylene oxide. Suitable foam stabilizers especially include foam stabilizers selected from the group of polyether-polydialkoxysilane copolymers, wherein the alkoxy groups are independently of one another selected in particular from aliphatic hydrocarbon radicals having one to ten carbon atoms, preferably from methyl, ethyl, n-propyl or i-propyl radicals.

The foam stabilizer C) may have a cloud point of at least 40° C., in particular of at least 50° C., preferably of at least 60° C., measured in a 4% by weight aqueous solution of the foam stabilizer C) with a stepped elevation of temperature from 20° C. starting with a heating rate of 2° C./min and determination of the cloud point by visual assessment of the time of onset of clouding. This is advantageous since the use of such foam stabilizers can further enhance the fire safety characteristics of the obtained rigid polyurethane foams. The abovementioned values for the cloud point may alternatively be determined by nephelometric means using DIN EN ISO 7027 (2000) without in any way being bound to the abovementioned procedure with combined temperature alteration. Very particular preference is given to foam stabilizers C) which have a high ethylene oxide to propylene oxide ratio in the polyether side chains of the silicone-polyether copolymers and simultaneously have a low (<5) dimethylsiloxane proportion. Examples thereof are shown in formula (II).

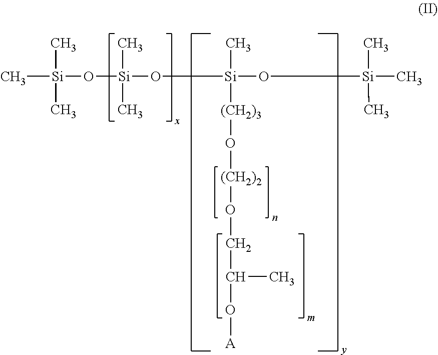

where x, y=integer>0 and x/y=dimethylsiloxane proportion<5,

n, m=integer>0 and n/m=ethylene oxide/propylene oxide ratio;

A=aryl, alkyl or H

The structural features reported in table 1 relate to the schematic structural formula of typical silicone stabilizers shown in formula (II). Such silicone stabilizers are obtainable for example from Schill+Seilacher GmbH or Evonik Industries AG. Among these foam stabilizers preference is given to those having an OH number in the range from 90 to 130 mg KOH/g (for example foam stabilizer 1 and 2).

TABLE 1

| | X/Y | n/m | OH |
|---|---|---|---|
| | Dimethylsiloxane | EO/PO | number in |
| | proportion | ratio | mg KOH/g |
| Foam stabilizer 1 | 2.73 | 1.66 | 100-130 |
| Foam stabilizer 2 | 3.64 | 1.89 | 90-120 |
| Foam stabilizer 3 | 9.44 | 0.51 | |
| Foam stabilizer 4 | 9.4 | 1.09 | |
| Foam stabilizer 5 | 9.89 | 2.33 | |

The proportion of the foam stabilizer C) in the one-component reaction system is preferably 0.2% to 4.0% by weight, particularly preferably 0.3% to 3.5% by weight, especially preferably 0.5% to 3.0% by weight, in each case based on A)+B)+C)+D)+E)+F)=100% by weight.

Employable catalysts D) in the one-component reaction system according to the invention in principle include any catalyst known to those skilled in the art as being suitable for this purpose, for example an amine catalyst. Especially preferred as the catalyst D) is 2,2′-dimorpholinyldiethyl ether since it catalyzes the reaction of the isocyanate with water particularly selectively.

The proportion of the catalyst D) in the one-component reaction system is preferably 0.1% to 2.0% by weight, particularly preferably 0.1% to 1.5% by weight, especially preferably 0.1% to 1.0% by weight, in each case based on A)+B)+C)+D)+E)+F)=100% by weight.

The reaction system further contains as the component E) at least one physical blowing agent having a boiling point<0° C. and optionally co-blowing agents. Preferred blowing agents are hydrocarbons, in particular the isomers of propane and butane. Preferred co-blowing agents are likewise physical blowing agents having a boiling point<0 ° C. which additionally have an emulsifying or solubilizing effect. It is preferable to employ dimethyl ether as a co-blowing agent.

A preferred embodiment contains dimethyl ether as a co-blowing agent and at least one compound selected from the group consisting of the isomers of propane and butane as a blowing agent.

The proportion of the component E) in the one-component reaction system is preferably 10% to 30% by weight, particularly preferably 10% to 25% by weight, especially preferably 12% to 22% by weight, in each case based on A)+B)+C)+D)+E)+F)=100% by weight.

The reaction system may also contain further assistant and additive substances F), for example flame retardants, cell regulators, plasticizers and diluents, for example long-chain chloroparaffins and paraffins, pigments or dyes, surface-active compounds and/or stabilizers against oxidative, thermal or microbial degradation/aging.

The proportion of further assistant and additive substances F) in the one-component reaction system is preferably 0.0% to 20.0% by weight, particularly preferably 0.0% to 15.0% by weight, especially preferably 0.1% to 15.0% by weight, in each case based on A)+B)+C)+D)+E)+F)=100% by weight.

Further details about the abovementioned and further starting materials may be found in the specialist literature, for example in Kunststoffhandbuch, volume VII, Polyurethane, Carl Hanser Verlag Munich, Vienna, 1st, 2nd and 3rd editions 1966, 1983 and 1993.

The reaction system may further contain an acid, preferably having a pKa value of at least 0, or an acid derivative such as for example an acid chloride, preferably an acid chloride of an aromatic carboxylic acid, for example phthalic acid dichloride, in particular in an amount of 10 to 500 ppm based on the amount of organic polyisocyanate component A), preferably of 50 to 300 ppm. The addition of such compounds allows a reaction of the prepolymer with itself, for example an allophanatization, to be very largely inhibited when a prepolymer is employed.

In a preferred embodiment the reaction system contains no short chain monools or hydroxyketones. In the context of the present application “short chain” is to be understood as meaning in particular monools and hydroxyketones having a molecular weight of <200 g/mol. Such compounds can act as cell openers, which is not desired here.

In a first embodiment the invention relates to a one-component reaction system for producing rigid polyurethane foams comprising the constituents:
A) at least one organic polyisocyanate component,
B) at least one isocyanate-reactive component whose isocyanate-reactive functional groups are exclusively those having at least one Zerewitinoff-reactive hydrogen atom,
C) at least one foam stabilizer,
D) at least one catalyst suitable for catalyzing the reaction of the polyisocyanate component A) with the isocyanate-reactive component B),
E) at least one physical blowing agent having a boiling point of less than 0° C. and optionally co-blowing agents and
F) optionally assistant and additive substances,
characterized in that
the isocyanate-reactive component B) contains at least 10% by weight, based on the sum of the weight fractions of A) to F)=100% by weight, of a polyether carbonate polyol.

In a second embodiment the invention relates to a one-component reaction system according to the first embodiment, characterized in that the component A) contains at least 90% by weight of aromatic polyisocyanates based on A)=100% by weight.

In a third embodiment the invention relates to a one-component reaction system according to either of embodiments 1 and 2, characterized in that the component B) contains a polyol having a functionality Fₙ of 1.0 to 4.0, preferably 1.5 to 3.5, particularly preferably 1.9 to 3.0.

In a fourth embodiment the invention relates to a one-component reaction system according to any of embodiments 1 to 3, characterized in that the component B) contains a polyether polyol having an OH number of 50 to 300 mg KOH/g, preferably 75 to 275 mg KOH/g, especially preferably 100 to 250 mg KOH/g.

In a fifth embodiment the invention relates to a one-component reaction system according to any of embodiments 1 to 4, characterized in that as foam stabilizer C) compounds having a structural formula (II)

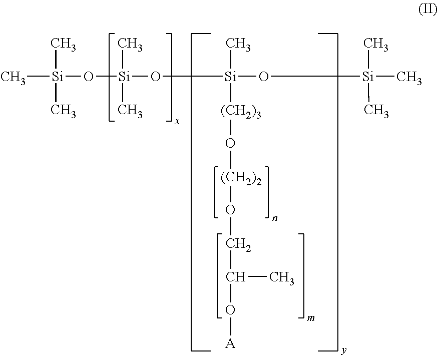

where x, y=integer>0 and x/y=dimethylsiloxane proportion<5,
n, m=integer>0 and n/m=ethylene oxide/propylene oxide ratio;
A=aryl, alkyl or H

are employed.

In a sixth embodiment the invention relates to a one-component reaction system according to any of embodiments 1 to 5, comprising the components:
30% to 70% by weight of organic polyisocyanate component A),
15% to 50% by weight of isocyanate-reactive component B),
0.2% to 4.0% by weight of a foam stabilizer C),
0.1% to 1.0% by weight of catalyst D) and
10% to 30% by weight of at least one physical blowing agent having a boiling point of less than 0° C. and optionally co-blowing agents (component E) and
0.0% to 20.0% by weight of assistant and additive substances (component F), in each case based on A)+B)+C)+D)+E)+F)=100% by weight.

In a seventh embodiment the invention relates to a one-component reaction system according to any of embodiments 1 to 6, characterized in that the isocyanate index is 350 to 550.

In an eighth embodiment the invention relates to a process for producing a one-component reaction system by reacting the organic polyisocyanate component A) with
B) an isocyanate-reactive component whose isocyanate-reactive functional groups are exclusively those having at least one Zerewitinoff-reactive hydrogen atom
in the presence of
C) at least one foam stabilizer,
D) at least one catalyst suitable for catalyzing the reaction of the semi-prepolymer with atmospheric humidity,
E) at least one physical blowing agent having a boiling point of less than 0° C. and optionally co-blowing agents and
F) optionally assistant and additive substances,
characterized in that
the isocyanate-reactive component B) contains at least 10% by weight, based on the sum of the weight fractions of A) to F)=100% by weight, of a polyether carbonate polyol.

In a ninth embodiment the invention relates to a process for producing a rigid polyurethane foam obtainable by mixing and reacting the components A) to F) of a one-component reaction system according to any of the embodiments 1 to 7 through exposure to moisture.

In a tenth embodiment the invention relates to a process for producing a rigid polyurethane foam comprising the steps of:
a) producing a one-component reaction system by a process according to the eighth embodiment and
b) exposing the one-component reaction system produced in step a) to moisture.

In an eleventh embodiment the invention relates to a rigid polyurethane foam obtainable by a process according to either of embodiments 9 and 10.

In a twelfth embodiment the invention relates to the use of a one-component reaction system according to any of embodiments 1 to 7 as 1-K expanding foam, wherein the one-component reaction system has been filled into a pressurized container.

In a thirteenth embodiment the invention relates to a pressurized container, in particular a single-use pressurized container, containing a one-component reaction system according to any of the embodiments 1 to 7.

In a fourteenth embodiment the invention relates to the use of rigid polyurethane foams according to the eleventh embodiment for applications in the construction industry.

Experimental Section

The rigid PUR foams according to the invention are produced by a two-stage process known to those skilled in the art in which the reaction components are discontinuously reacted with one another and then introduced into or onto suitable molds/substrates/cavities for curing. Examples are described in USA-A 2 761 565, in G. Oertel (ed.) “Kunststoff-Handbuch”, Volume VII, Carl Hanser Verlag, 3rd edition, Munich 1993, pages 284 ff., and in K. Uhlig (ed.) “Polyurethan Taschenbuch”, Carl Hanser Verlag, 2nd edition, Vienna 2001, pages 83-102.

Measurement of hydroxyl numbers was performed by NIR spectroscopy (Lambda 950, Perkin-Elmer, PC-controlled). The combination vibration of v(OH) and δ(OH) base vibrations were measured for the samples and calibration samples employed in the examples in the range from 2050 to 2100 mm The samples and calibration samples were temperature-controlled to 20° C. for the measurements. The calibration samples employed were polyether polyols whose OH number was determined according to the standard DIN 53240-2 (1998). The results of the NIR spectroscopy of the samples were compared with the results of the calibration samples by the Max-Min method to determine the OH number of the samples.

To determine the NCO content in the polyisocyanate the standard EN ISO 11909 (2007) was used.

Input Materials

| | |
|---|---|
| Polyol 1 | linear propylene glycol-started propylene oxide polyether, |
| | equivalent weight 501 g/mol, OH Number 112 mg KOH/g |
| Polyol 2 | glycerol-started propylene oxide polyether, equivalent |
| | weight 243 g/mol, OH Number 231 mg KOH/g |
| Polyol 3 | glycerol-started propylene oxide polyether, equivalent |
| | weight 360 g/mol, OH Number 156 mg KOH/g |
| Polyol 4 | linear propylene glycol-started polyether carbonate polyol, |
| | equivalent weight 500 g/mol, OH Number 112 mg KOH/g |
| Polyol 5 | glycerol-started polyether carbonate polyol, equivalent |
| | weight 355 g/mol, OH Number 158 mg KOH/g |
| Polyol 6 | glycerol/propylene glycol-started polyether carbonate polyol, |
| | equivalent weight 330 g/mol, OH Number 170 mg KOH/g |
| FR | flame retardant, tris(2-chloroisopropyl) phosphate (TCPP) |
| Stab 1 | polyether siloxane foam stabilizer (TEGOSTAB B 8870, |
| | Evonik) |
| Stab 2 | polyether siloxane foam stabilizer (Niax Silicone L-6164, |
| | Momentive) |
| Stab 3 | polyether siloxane foam stabilizer (TEGOSTAB B 8871, |
| | Evonik) |
| Cell opener | polysiloxane (Tegiloxan 100, Evonik) |
| Catalyst | 2,2′-dimorpholinyl diethyl ether (DMDEE) |
| Blowing | n-butane |
| agent 1 | |
| Blowing | isobutane (Merck) |
| agent 2 | |
| Blowing | dimethyl ether (Merck) |
| agent 3 | |
| Blowing | propane |
| agent 4 | |
| Poly- | Desmodur ® 44V20L, polymeric MDI having an isocyanate |
| isocyanate | content of 31.5% by weight (Covestro Deutschland AG) |

Producing the 1K Formulations in Single-Use Pressurized Containers

To produce the 1K formulations in single-use pressurized containers the required amounts of the polyol components were initially charged in a mixing vessel in turn and mixed with appropriate amounts of catalyst, blowing agent and assistant and additive substances (table 2). The mixture was subsequently transferred into a single-use pressurized container. Finally the amount of polyisocyanate corresponding to the index was added to the can and the can was sealed tight with a valve. The required amounts of the blowing agents were added via the fitted valve using a suitable metering unit. Finally, the single-use pressurized container was shaken until complete homogenization of the 1K formulation. The thus-produced 1K formulations are reported hereinbelow in the examples in table 3.

Determination of Shrinkage/Swellage (Ddimensional Stability)

The rigid PUR foam is dispensed from the can into a mold (600 mm×30 mm×60 mm) which has been lined with paper and sprayed with water. The resulting rigid PUR foam strand is removed from the mold after 1 day. Thickness is measured with a thickness tester in the middle of the strand (at 300 mm) The ratio of rigid PUR foam strand thickness to mold width (30 mm) represents the dimensional stability (shrinkage/swelling). The thickness of the middle of the strand (at 300 mm) is re-measured with a thickness tester 7 days after foaming The moisture required for curing is provided through the spraying of the paper with water. This procedure is independent of the atmospheric humidity present in each case and provides the most reproducible results.

All results relating to the 1-K reaction systems produced according to the present application and the resulting rigid polyurethane foams (free-rise foams) and their properties are summarized in table 3.

TABLE 2
1K formulation

| | | Example | | | | | |
|---|---|---|---|---|---|---|---|
| | | 1* | 2 | 3* | 4 | 5* | 6 |
| Polyol 1 | g | 91.20 | — | 91.20 | — | 30.12 | 30.12 |
| Polyol 2 | g | 4.96 | 4.96 | — | — | — | — |
| Polyol 3 | g | — | — | 4.96 | — | 30.12 | — |
| Polyol 4 | g | — | 91.20 | — | 91.20 | — | — |
| Polyol 5 | g | — | — | — | 4.96 | — | — |
| Polyol 6 | g | — | — | — | — | — | 30.12 |
| FR | g | — | — | — | — | 33.13 | 33.13 |
| Stab 1 | g | 2.48 | 2.48 | 2.48 | 2.48 | — | — |
| Stab 2 | g | 0.59 | 0.59 | 0.59 | 0.59 | — | — |
| Stab 3 | g | — | — | — | — | 5.42 | 5.42 |
| Cell opener | g | 0.08 | 0.08 | 0.08 | 0.08 | — | — |
| Catalyst | g | 0.69 | 0.69 | 0.69 | 0.69 | 1.20 | 1.20 |

*comparative example

TABLE 3
Can formulation

| | | Example | | | | | |
|---|---|---|---|---|---|---|---|
| | | 1* | 2 | 3* | 4 | 5* | 6 |
| Total amount of 1K | g | 167.4 | 169.36 | 169.36 | 171.66 | 218.80 | 214.65 |
| formulation from table | | | | | | | |
| 2 | | | | | | | |
| Blowing agent 1 | g | — | — | — | — | 24.9 | 25.0 |
| Blowing agent 2 | g | 53.2 | 53.8 | 53.2 | 53.8 | 7 | 7.1 |
| Blowing agent 3 | g | 29.3 | 29.6 | 29.3 | 29.6 | 13.7 | 13.7 |
| Blowing agent 4 | g | 15.1 | 15.2 | 15.1 | 15.2 | 27 | 27 |
| Polyisocyanate | g | 222.24 | 224.83 | 224.83 | 222.19 | 224.70 | 231.23 |
| Fill amount | g | 487.18 | 492.86 | 492.86 | 492.57 | 516.06 | 518.67 |
| Index | | 460.0 | 460.0 | 460.0 | 460.0 | 500.0 | 500.0 |
| Proportion of polyether | % by | 0 | 31.3 | 0 | 31.8 | 0 | 12.5 |
| carbonate polyol in can | weight | | | | | | |
| formulation | | | | | | | |
| Dimensional stability | % | 4 | 0 | −6 | −0.33 | −20.67 | 1.7 |
| of strand after 1 day | | | | | | | |
| Dimensional stability | % | 6 | 0.67 | −3 | 0 | −30.67 | 0 |
| of strand after 7 days | | | | | | | |

*comparative example

Examples 1, 3 and 5 were produced without the use of a polyether carbonate polyol and exhibit strong swellage (example 1) and shrinkage (examples 3 and 5) of the rigid PUR foam. Substitution of the polyether polyols from example 1 and 3 by appropriate polyether carbonate polyols results in markedly reduced swellage/shrinkage of the obtained rigid PUR foams in examples 2 and 4. A markedly improved dimensional stability of the rigid PUR foam compared to example 5 is likewise obtained in example 6 through the use of at least 10% by weight, based on the sum of the parts by weight of A) to F)=100% by weight, of a polyether carbonate polyol as an isocyanate-reactive component.

1. A one-component reaction system for producing rigid polyurethane foams, comprising:
A) at least one organic polyisocyanate component,
B) at least one isocyanate-reactive component wherein the isocyanate-reactive functional groups are exclusively isocyanate-reactive functional groups having at least one Zerewitinoff-reactive hydrogen atom,
C) at least one foam stabilizer,
D) at least one catalyst suitable for catalyzing the reaction of the polyisocyanate component A) with the isocyanate-reactive component B),
E) at least one physical blowing agent having a boiling point of less than 0° C., and optionally co-blowing agents, and
F) optionally, assistant and/or additive substances,
wherein
the isocyanate-reactive component B) comprises at least 10% by weight, based on 100% by weight of the sum of the weight fractions of components A) to F), of a polyether carbonate polyol.

2. The one-component reaction system as claimed in claim 1, wherein component A) contains at least 90% by weight of aromatic polyisocyanates based on 100% by weight of component A).

3. The one-component reaction system as claimed in claim 1, wherein component B) contains a polyol having a functionality Fₙ of 1.0 to 4.0, preferably 1.5 to 3.5, particularly 1.9 to 3.0.

4. The one-component reaction system as claimed in claim 1, wherein component B) contains a polyether polyol having an OH number of 50 to 300 mg KOH/g, preferably 75 to 275 mg KOH/g, especially preveably 100 to 250 mg KOH/g.

5. The one-component reaction system as claimed in claim 1, wherein as foam stabilizer C) compounds having a structural formula (I) 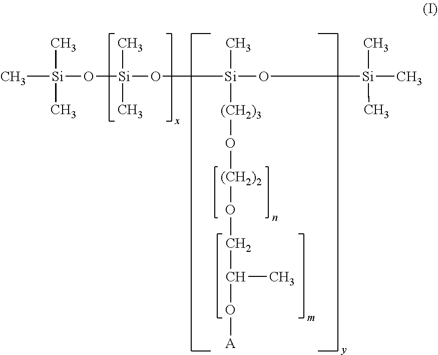
wherein x, y=integer>0 and x/y=dimethylsiloxane proportion<5,
n, m=integer>0 and n/m=ethylene oxide/propylene oxide ratio;
A=aryl, alkyl or H
are employed.

6. The one-component reaction system as claimed in claim 1, comprising:
30% to 70% by weight of organic polyisocyanate component A),
15% to 50% by weight of isocyanate-reactive component B),
0.2% to 4.0% by weight of a foam stabilizer C),
0.1% to 1.0% by weight of catalyst D) and
10% to 30% by weight of at least one physical blowing agent having a boiling point of less than 0° C. and optionally co-blowing agents (component E) and
0.0% to 20.0% by weight of assistant and additive substances (component F),
with the sum of the % by weights of components A), B), C), D), E), and F) totaling 100% by weight.

7. The one-component reaction system as claimed in claim 1, wherein the isocyanate index is 350 to 550.

8. A process for producing a one-component reaction system by reacting
A) an organic polyisocyanate component and
B) an isocyanate-reactive component wherein the isocyanate-reactive functional groups are exclusively isocyanate-reactive functional groups having at least one Zerewitinoff-reactive hydrogen atom,
in the presence of
C) at least one foam stabilizer,
D) at least one catalyst suitable for catalyzing the reaction of the semi-prepolymer with atmospheric humidity,
E) at least one physical blowing agent having a boiling point of less than 0° C., and optionally, co-blowing agents, and
F) optionally, assistant and/or additive substances,
wherein the isocyanate-reactive component B) comprises at least 10% by weight, based on 100% by weight of the sum of components A) to F), of a polyether carbonate polyol.

9. A process for producing a rigid polyurethane foam obtainable by mixing and reacting the components A) to F) of a one-component reaction system as claimed in claim 1 through exposure to moisture.

10. A process for producing a rigid polyurethane foam comprising
a) producing a one-component reaction system by a process as claimed in claim 8, and
b) exposing the one-component reaction system produced in step a) to moisture.

11. A rigid polyurethane foam obtainable by a process as claimed in claim 10.

12. (canceled)

13. A pressurized container, in particular a single-use pressurized containing a one-component reaction system as claimed in claim 1.

14. (canceled)

15. (canceled)

16. (canceled)

17. (canceled)

18. (canceled)

19. (canceled)
